(19) United States
(12) Patent Application Publication
(10) Pub. No.: US 2008/0147807 A1
(43) Pub. Date: Jun. 19, 2008

(54) METHOD AND SYSTEM FOR DELIVERING AND CONFIRMING ACKNOWLEDGMENT OF EMPLOYMENT MESSAGES

(76) Inventor: Brenda Borkenhagen, Schaumburg, IL (US)

Correspondence Address: Pauley Petersen & Erickson, Suite 365, 2800 West Higgins Road, Hoffamn Estates, IL, 60169, US

(21) Appl. No.: 11/837,310

(22) Filed: Aug. 10, 2007

Related U.S. Application Data
(60) Provisional application No. 60/875,747, filed on Dec. 18, 2006.

(51) Int. Cl. G06F 15/16

(52) U.S. Cl. 709/206

(57) ABSTRACT

This invention relates to a method and system for electronically posting and tracking messages to employees. The method includes forwarding an electronic message from a first employee to a second employee and associating a new message indicator with the electronic message until the electronic message is accessed by the second employee. The computer system displays to the second employee through the user interface the new message indicator associated with the electronic message. An additional step of the method includes receiving an electronic accountability response from the second employee indicating the second employee has reviewed and accepts responsibility for a content of the electronic message and associating a completed message indicator associated with the electronic message upon receiving the electronic accountability response.

### CROSS REFERENCE TO RELATED APPLICATION(S)

This Patent Application claims the benefit of Provisional U.S. Patent Application Ser. No. 60/875,747, filed on 18 Dec. 2006. The co-pending provisional application is hereby incorporated by reference herein in its entirety and is made a part hereof, including but not limited to those portions which specifically appear hereinafter.

### BACKGROUND OF THE INVENTION

This invention relates generally to a method and a system, e.g., a computer system with appropriate software, for providing a managerial tool used to electronically post messages, and to track associate or employee compliance with the reading of the messages. Currently, managers often post paper copies of documents they need to communicate with employees onto cork boards or bulletin boards. Another option is to e-mail the message directly to the employee, but tools in conventional e-mail systems, e.g., “read receipts” and replies from the recipient, do not accurately communicate whether the information has been read and understood by the recipient and/or make tracking of employee acceptance difficult. There is no way to track the effectiveness of this communication without relying on a manual, labor-intensive process. There is a need for an improved system for delivering and tracking messages delivered to employees.

### SUMMARY OF THE INVENTION

A general object of the invention is to provide an improved message delivery system that generates an acknowledgement of responsibility of the content of a message from the recipient employee and tracks and stores employee acknowledgments.

A more specific objective of the invention is to overcome one or more of the problems described above.

The general object of the invention can be attained, at least in part, through a method for electronically posting and tracking messages to employees. The method includes forwarding an electronic message created by a first employee to a second employee and displaying the electronic message through a user interface for the second employee. The method further includes associating a new message indicator with the electronic message until the electronic message is accessed by the second employee and displaying to the second employee through the user interface the new message indicator associated with the electronic message.

Additional steps in the method include receiving an electronic accountability response from the second employee indicating the second employee has reviewed and accepts responsibility for a content of the electronic message, and associating a completed message indicator associated with the electronic message upon receiving the electronic accountability response. The method also includes displaying to the second employee through the user interface the completed message indicator associated with the electronic message.

The invention further comprehends a method for electronically posting and tracking messages to employees including displaying through a user interface for a first employee at least one of a list of the employees by name and a list of a plurality of workgroups, wherein each of the employees is designated in at least one of the plurality of workgroups as a function of title, department, job function or tasks. The method also includes receiving from the first employee an electronic message and a recipient selection, wherein the recipient selection includes at least one of an employee selection from the list of employees by name and a workgroup selection from the list of the plurality of workgroups and forwarding the electronic message to a message inbox of each employee associated with the recipient selection.

Additional steps of the method include associating a new message indicator with the electronic message in the message inbox for each employee associated with the recipient selection until the electronic message is accessed and displaying a request for an accountability response with the electronic message in the message inbox for each employee associated with the recipient selection. The method includes receiving an electronic accountability response from a responding employee of the employees associated with the recipient selection indicating acceptance of responsibility for a content of the electronic message and displaying a completed message indicator associated with the electronic message in the message inbox of the responding employee upon receiving the electronic accountability response. Another step of this method includes storing a record of the electronic accountability response on a recordable medium that is accessible by the first employee.

The invention still further comprehends a computer system including software for displaying at least two of the following: date sensitive response tracked electronic messages, non-tracked department news items, non-tracked limited duration notifications; and anonymous suggestion submissions. The electronic messages, department news items, notifications and suggestion submissions reside in a database. The hardware executing the software includes a recordable media storing the database.

Other objects and advantages will be apparent to those skilled in the art from the following detailed description taken in conjunction with the appended claims and drawings.

### BRIEF DESCRIPTION OF THE DRAWINGS

FIG. 1 is a flow diagram illustrating a method according to one embodiment of this invention.

FIG. 2 is a flow diagram illustrating a method according to another embodiment of this invention.

FIG. 3 is a flow diagram illustrating a method according to another embodiment of this invention.

FIG. 4 is a screenshot of a homepage according to one embodiment of this invention.

FIG. 5 is a screenshot of an opened message according to one embodiment of this invention.

FIG. 6 is a screenshot of a blank message according to one embodiment of this invention.

FIG. 7 is a screenshot of a recipient selector according to one embodiment of this invention.

FIG. 8 is a screenshot of a reports page according to one embodiment of this invention.

FIG. 9 is a screenshot of a report according to one embodiment of this invention.

### DETAILED DESCRIPTION OF THE INVENTION

This invention relates generally to a method and a system, e.g., a computer network system with appropriate software, for a managerial tool used to electronically post messages, and to track associate or employee compliance with the reading of the messages.

In this invention, these postings are made electronically and recipients interact with the messages via a web-based graphical user interface.

This invention finds application to various different industries and organizations. For the sake of convenience only this description includes medical professionals and hospital related applications. Those skilled in the art and guided by the teachings herein, can readily apply or adapt this invention to other settings, such as universities, manufacturing plants, financial institutions and any other environment needing to disseminate or transmit information.

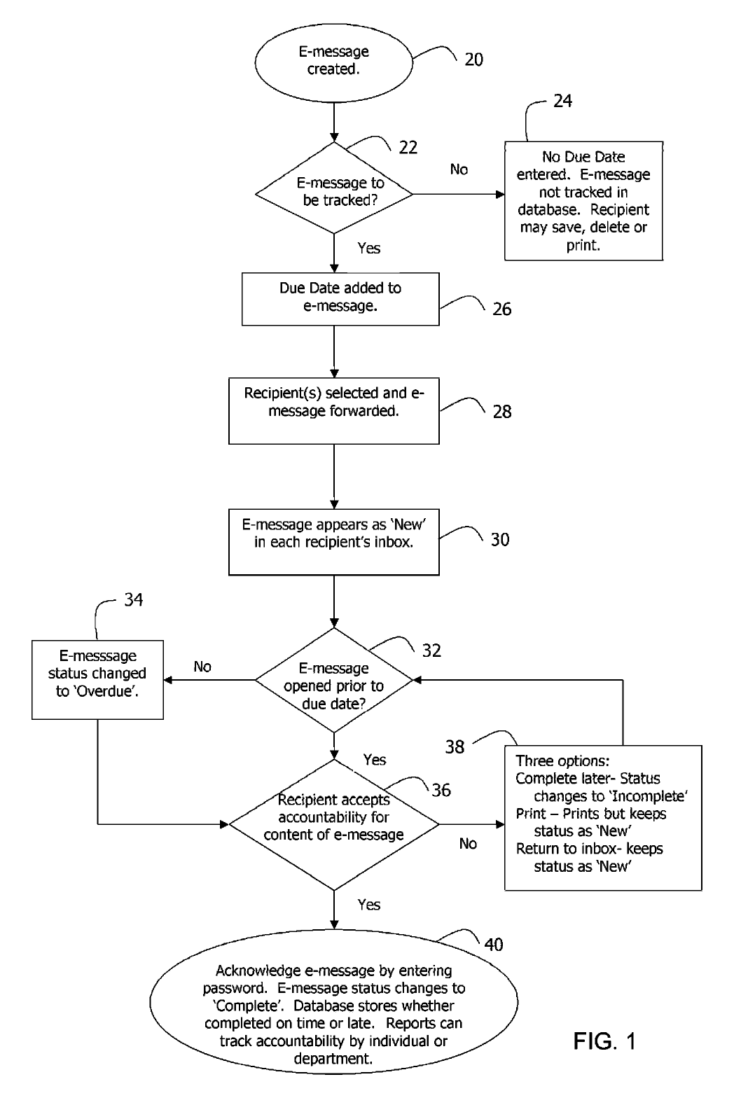

FIG. 1 is a flow diagram useful in describing a method for electronically posting and tracking messages to employees according to one embodiment of this invention. In step 20, an electronic message, or “e-message” for short, is created by a first employee, such as but not necessarily a manager, using software on a computer having a processor, a recordable drive, a keyboard, a mouse, etc. The first employee's computer is connected to user interfaces, e.g., computers, of other employees by a network interface, such as is known and available to those of ordinary skill in the art of computer systems. As will be appreciated, the software executing the method can optionally be located on a recordable medium remote from the first employee's computer, but accessible through the network.

In step 22, the first employee identifies whether the electronic message is to be tracked by the computer system. If the first employee does not need or want the electronic message to be tracked, the recipient is free to save, delete, and/or print the received message, as indicated in box 24. If tracking is desired, the computer system automatically creates a file, or equivalent structure, in a database on a recordable medium of the computer system. In order to select or enable the tracking feature, the first employee will select an appropriate interface device: such as a radio button, a drop down button, etc., through the user interface of the computer system.

In step 26, the first employee selects a suitable due date and the due date is associated or added to the electronic message, such as in a date formatted field. Input methods to the due date field include text entry boxes, drop down calendars and any other suitable software-created interface device. Desirably, the first employee selects a due date related to the contents of the electronic message or some other reasonable response time. The computer system records the due date for the electronic message, such as in the memory register or written to the file for the electronic message and stored in the database.

In step 28, the first employee selects the desired recipient for the electronic message. Recipients desirably have a user-specific account on the computer system, such as a login onto the software program or application. In one embodiment, the first employee chooses or picks the recipient or multiple recipients for the electronic message, such as from a list of system users. According to another embodiment of this invention, employees can be organized in groups, such as departments, groups and positions. Other groupings are possible including job title, function, classification and/or any other suitable criteria. The first employee selects one or more workgroups of employees. Workgroups represent a plurality of employees with a common basis. The computer system includes user defined workgroups or filters.

In one embodiment of this invention, the first employee also selects a category designation for the electronic message. Desirably, such categories are system defined and can be modified by the system administrator. Exemplary electronic message categories include birthday, bonus, census, clinical, construction, documentation, emergency, equipment, holidays, human resources, information systems, maintenance, nursing, overtime, pharmacy, phone directory, photos, physicians, planning, policies, presentations, quality improvement, employee recognitions, safety, scheduling, social events and any other relevant basis for grouping communications.

The first employee enters the text of the electronic message, for example in a text box. The first employee also may attach and/or embed files or documents to compliment or supplement the text. The contents of the electronic message are saved to the computer system, such as written to the database.

Also in step 28, the electronic message is forwarded to the recipients, such as a second employee. Forwarding includes sending, transmitting, copying, posting, routing and any other suitable action to electronically communicate the electronic message to the recipients over the network.

The computer system displays the electronic message through or by a user interface for the second employee. Displaying includes showing at least a portion of the electronic message to the second employee, such as when logged into a network-connected personal computer, a terminal and/or any suitable hardware configuration. According to an embodiment of this invention, the electronic message displays in a browser window, such as Microsoft® Internet Explorer®, Firefox and/or any other suitable networked or collaborative user interface.

In step 30, upon sending the electronic message from the first employee, the computer system generates and/or associates a new message indicator, flag or status with respect to the electronic message, such as displayed or viewed in an inbox of the recipient second employee. The new message indicator displays on the second employee's user Interface until the electronic message is accessed or opened by the second employee. According to one embodiment of this invention, the new message indicator increases intensity as displayed on the user interface, such as changing from a blue color to a red color at a set period prior to expiration of the due date.

In step 32, the second employee opens or displays the electronic message. If the electronic message is opened prior to the due date then the method proceeds to step 36, but if the second employee fails to open the electronic message prior to the due date, the status and the corresponding indicator changes to overdue in step 34. Desirably, the second employee can sort or query electronic messages by order of due date or other relevant prioritization criteria. Optionally, the computer system can continuously perform such prioritizations.

Steps of the method include without limitation execution continuously, discretely, batch-wise, at designated intervals, as needed and any other useful way of completing the desired task. Furthermore, steps can be executed serially, sequentially, randomly, in parallel and/or any other way to efficiently utilize system resources.

In step 36, the second employee accepts accountability for the content of the electronic message and the computer system accepts the accountability response. By accepting accountability, the second employee indicates that he/she has fully read and comprehends the contents of the entirety of the electronic message. By generating the user accountability response, such as by double clicking a software-generated input box, the second employee indicates he/she has reviewed and accepts responsibility for the contents of the electronic message.

If a second employee does not generate the accountability response, the second employee has three options as listed in box 38. The second employee decides he/she will complete the task later and closes the message, the computer system changes the status of the electronic message to incomplete, such as when finding a lengthy document requiring more time to read then currently available. A second option is that the second employee prints the electronic message to a paper printer but keeps the status as new. A third option is to return the electronic message to the inbox still with a new message indication. As shown in FIG. 1, these unaccepted messages then remain in the inbox for processing, such as by step 32 at a future time.

When the second employee generates the electronic accountability receipt the second employee can be asked to enter their system password as a confirmation or acknowledgement of the intended action, as shown in step 40. The message status then changes to complete and the database is updated with a date stamp when completed and/or a field indicating timely completion. The message complete status is displayed by the user interface to second employee and/or the first employee. According to one embodiment of this invention, the first employee accesses the user accountability response of the second employee.

Step 40 also includes associating a completed message indicator associated with the electronic message upon receiving the electronic accountability response. The second employee receives or views a completed message indicator by the user interface. The computer system allows the first employee to optionally generate one or more reports or queries based upon particular details regarding one or more electronic messages, for one or more respondents. Reports include standard reports, such as by employee name or overdue message, and include customizable or ad hoc reports. The first employee reviews the status of the electronic message.

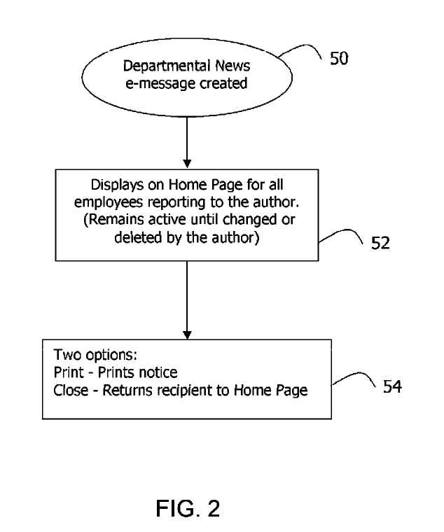

According to another embodiment as shown in FIG. 2, the computer system allows the first employee to create a “department news” electronic message, i.e., a general announcement, in step 50. “Department news” desirably includes announcements, promotions, information and other generally informative data but the content of which does not rise to the importance of accountability response tracking. The first employee enters, types and/or attaches the desired news content, for example in a text entry box. In one embodiment of this invention, once the department news message is posted, all employees/work groups associated with the first employee will see or have access to the department news message in their respective account. In other words, department news messages are sent to everyone, and not to discrete, selected employees.

Step 52 includes displaying the department news message on each selected employee's homepage through a user interface. Those skilled in the art and guided by the teachings herein will appreciate that departments can include groupings of any relevant criteria, such as by function, location and any other distinguishing characteristic. The user interface of the computer system displays the department news electronic message or remains active until changed or deleted by the first employee, the author.

Step 54 provides two options for the department employees or users regarding the department news electronic message. The first option includes printing the notice or department news electronic message, and the second option includes returning to the employees' or recipients' homepage. A “homepage” is typically the first screen displayed by the user interface after a user logs into the computer system. Desirably, the homepage allows for or facilitates navigation to the desired features and functions of the software program or application.

Typically, the department news is grouped by category, such as, but not limited to, social events, birthdays, human resources, etc. The categories of the department news are configurable, such as by the system administrator. The homepage of the user displays the category, the title and the icon associated with the department news and the user clicks any of these items to open the message.

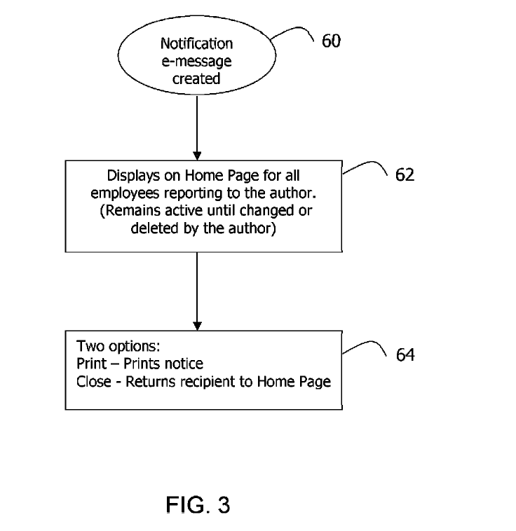

According to another embodiment as shown in FIG. 3, the method includes step 60 for creating a notification. Notifications desirably appear on the homepage of the user and typically include short term informational items. Generally, but not necessarily, notifications have a bullet point form, such as “Donuts in the break room this morning.” Reading notifications is not tracked and there is no accountability response generated. A manager or a user of appropriate system access creates the notification, such as by entering the information in a text box. The manager then saves and posts the notification and the notification displays for all employees related to that author (e.g., all employees working under the authority of the author manager). In one embodiment, the computer system allows for sending of all or various combinations of the communications discussed herein, i.e., electronic messages, department news, and notifications.

In step 62, the notification displays on the user homepage of the selected employees. The notification remains active until changed or deleted by the author. Alternately, the author can select an expiration date for the notification when it will automatically be deleted from each user's homepage. Employees may receive notifications from more than one author, such as a notification about donuts from their manager and a notification about system availability during a server reboot from a system administrator.

Step 64 includes two options for the employee or associate regarding the notification. The first option is to print the notification to a paper printer, such as one on the network. The second option is to close the notification and return to the homepage.

According to another embodiment of this invention, the computer system includes suggestion submission capabilities. The suggestions are an anonymous device for employees to submit or generate their comments, views and ideas to the management team and/or the system administrator. Suggestions or anonymous electronic responses include a category and then a body or text of the suggestion. Categories are system defined, such as by an administrator. Categories include safety, cost savings, patient care and any other suitable grouping.

The computer system generally provides multiple levels of access and authority to different users and accounts. Staff, manager, director, executive and system administrator are possible types of accounts. Typical privileges that can be given to the accounts include create electronic messages, receive electronic messages, create notifications, receive notifications, create department news, view department news, create suggestions, view suggestions, manage users, run reports, manage electronic message categories, manager department new categories, manage departments, manage user positions and manage data services.

According to another embodiment of this invention the method for electronically posting and tracking messages to employees includes the following steps. A user interface displaying for a first employee at least one of a list of the employees by name and a list of a plurality of workgroups, wherein each of the employees is designated in at least one of the plurality of workgroups as a function of title, department, Job function or tasks. The first employee sends and the second employee receives an electronic message. The recipient selection includes at least one of an employee selected from the list of employees by name and a workgroup selection from the list of the plurality of workgroups.

The electronic message is forwarded to an inbox of each employee associated with the recipient selection. A new message indicator associated with the electronic message displays in the message with an inbox for each employee associated with the recipient selection until the electronic message is accessed. Upon access of the electronic message, the computer system displays through the user interface a request for an accountability response for each employee associated with the recipient selection. The computer system receives the electronic accountability response from a responding employee of the employees associated with the recipient selection indicating acceptance of responsibility for a content of the electronic message.

The computer system displays a completed message indicator associated with the electronic message in the message inbox of the responding employee upon receiving the electronic accountability response. The method also includes storing a record of the electronic accountability response on a recordable medium that is accessible by the first employee.

The invention also comprehends software code on a recordable medium and executable on a data processing machine, such as for implementing the steps described herein.

According to one embodiment of this invention, the computer system includes software for displaying at least two of the following items date sensitive response tracked electronic messages, non-tracked department news items, non-tracked limited duration notifications and anonymous suggestion submissions. The electronic messages, department news items, notifications and suggestion submissions reside in a database. The software executes on hardware including recordable media storing the database.

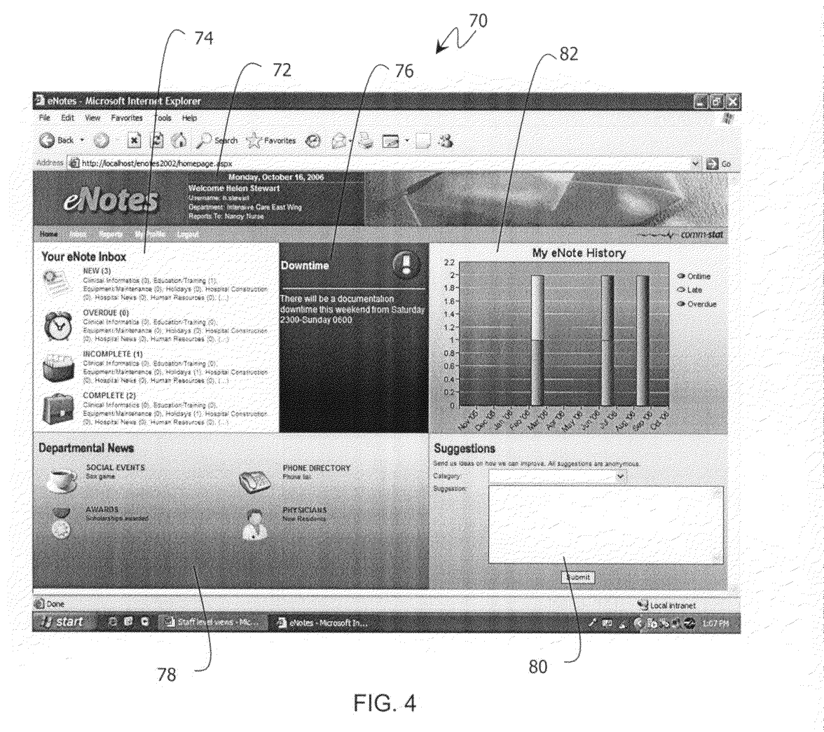

FIG. 4 shows a homepage according to an embodiment of this invention. The homepage is displayed by a browser as discussed above. The homepage is accessed, such as by a secured internal network (intranet) or by the World Wide Web (internet). The user first accesses a login screen by entering an address or clicking on an icon. The user then enters their login or account name, e.g., JohnSmith1. The user also enters their password, e.g., ******* Desirably the computer system utilizes strong passwords, such as a combination of numbers, letters and/or different cases of a minimum length.

The homepage 70 includes six different panes within the system window. Welcome banner pane 72 is displayed, for example, on the top panel and includes user specific information, such as user name, department and supervisor. Welcome banner pane 72 allows the user to confirm their account since they want to access information relevant to them. A pediatric nurse does not need to read the electronic messages for a cardiologist.

Homepage 70 also includes inbox pane 74 displaying at least a portion of the electronic messages they have received. According to an embodiment of this invention, the inbox groups the electronic messages into status based on criteria, such as the due date. These status indicators include new, overdue, incomplete and complete. A count of messages by each status indicator is included. The user clicks on an icon to access the corresponding electronic messages. The categories of the electronic message are displayed below the status indicators.

Notifications pane 76 is shown, for example, in a central panel. Notifications include short term bullet informational items as discussed above. Notifications generally are reserved for urgent items.

Department News pane 78 is shown for example in a lower left panel. According to an embodiment of this invention, department news items are displayed by categories, such as selected by the author. A user selects a category icon and clicks it to access the items below.

Suggestions pane 80 is shown, for example, in a lower right panel. According to an embodiment of this invention the user enters suggestions for anonymously submitting as an electronic suggestion message to an upper level employee. The user types their suggestion into the panel and clicks the submit button to record the entry, such as into a database record. Optionally the computer system assigns managers to the entered suggestions with completion dates and status update fields.

History pane 82 is shown, for example in an upper right panel. History pane 82 includes graphical and/or tabular summaries, such as system determined or user defined. According to an embodiment of this invention, a count of electronic messages by month and status is shown as a bar chart.

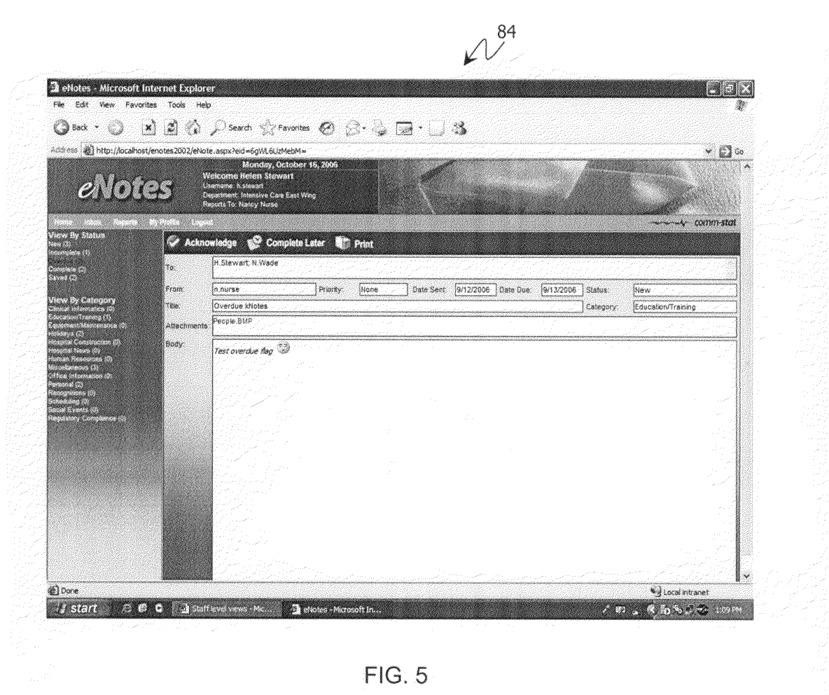

FIG. 5 shows an electronic message opened through user inbox pane 84. The electronic message includes the following fields: to (recipients), from (author), priority, date sent, due date, status, category, attachments and body. The screen also includes buttons and/or icons for actions related to the electronic message, including acknowledge, complete later and print.

The opened message includes a welcome banner 72 as discussed above, a menu bar and a quick sort list. The menu bar includes home, inbox, reports, my profile and logout. The quick sort list includes view by status and view by category. Status includes new, incomplete, overdue, complete and saved. Categories include clinical informatics, education/training, equipment/maintenance, holidays, hospital construction, hospital news, human resources, miscellaneous, office information, personal, recognitions, scheduling, social events and regulatory compliance.

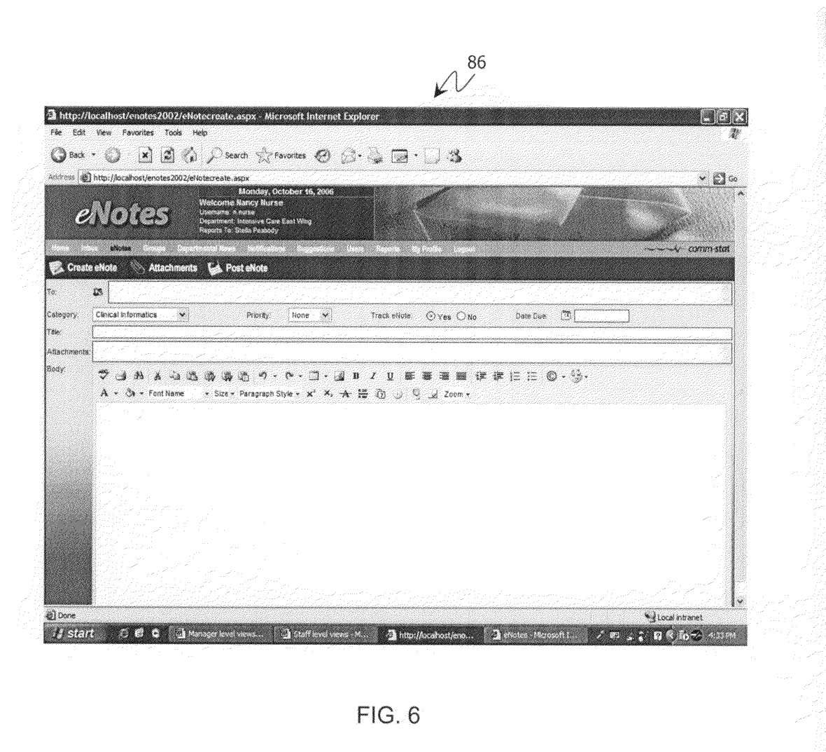

FIG. 6 shows a blank electronic message 86 open for authoring, such as by the first employee discussed above. This screen is displayed, for example, when a manager wants to distribute information about annual medical staff certifications. The welcome banner as discussed above is included. A menu bar includes home, inbox, electronic message (“eNote”), groups, department news, notifications, suggestions, users, reports, my profile and logout. The screen includes buttons to create note, attachments, and post note. The post note button delivers or sends the electronic message to the selected recipients' inboxes.

The screen includes several fields for entry, such as to (recipients), category, priority, track, date due, title, attachments and body. Those skilled in the art and guided by the teachings herein readily appreciate fields broadly includes drop down menus, text boxes, radio buttons and/or any other suitable software-generated interface device. In FIG. 6, the due date field is not active until the “track enote yes” button is selected.

Desirably, the body field includes toolbars, such as for formatting the electronic message. Typical tool options include, without limitation, bold, italics, justification, bullets, numbering, insert symbols, insert graphics (e.g., smiley faces), font size, font type, style, superscript, subscript, insert date, insert time, view zoom, print, spell check, cut, paste, copy, etc.

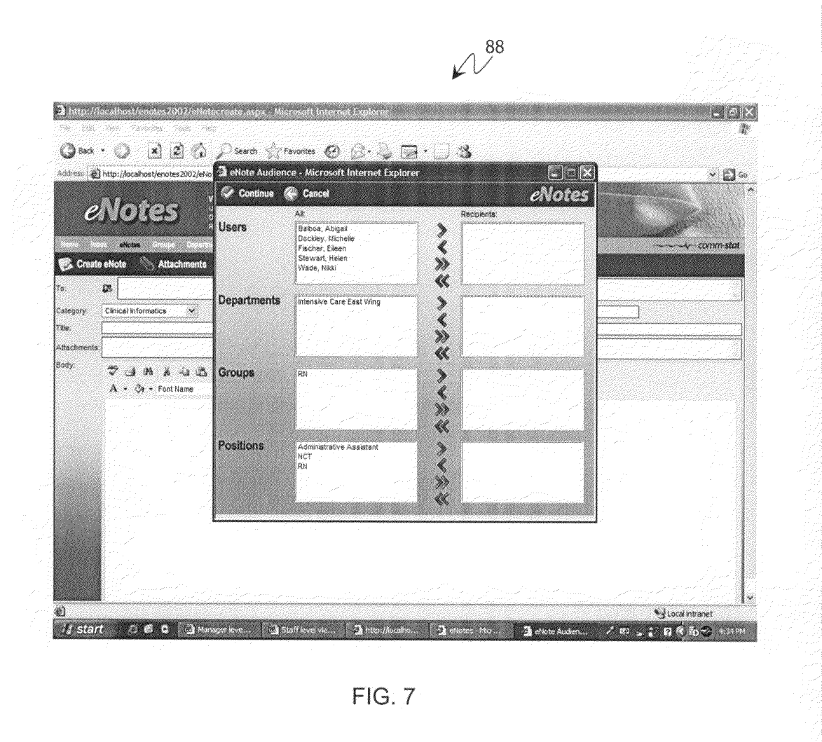

FIG. 7 shows recipient selection screen 88 to aid author or first employee in selecting the distribution list for the electronic message before sending. A welcome banner as discussed above is included. The screen includes software-generated buttons for continue or cancel. The screen also includes four types of selection criteria: users (individuals), departments, groups and positions. According to a preferred embodiment of this invention the names of entries of the selection criteria reside in either an “all” designation or a “recipient” designation. Desirably individual and multiple selections are possible, such as by holding down the control key and selecting the names. Directional arrows to move selected names or the entire list in either direction between lists are provided.

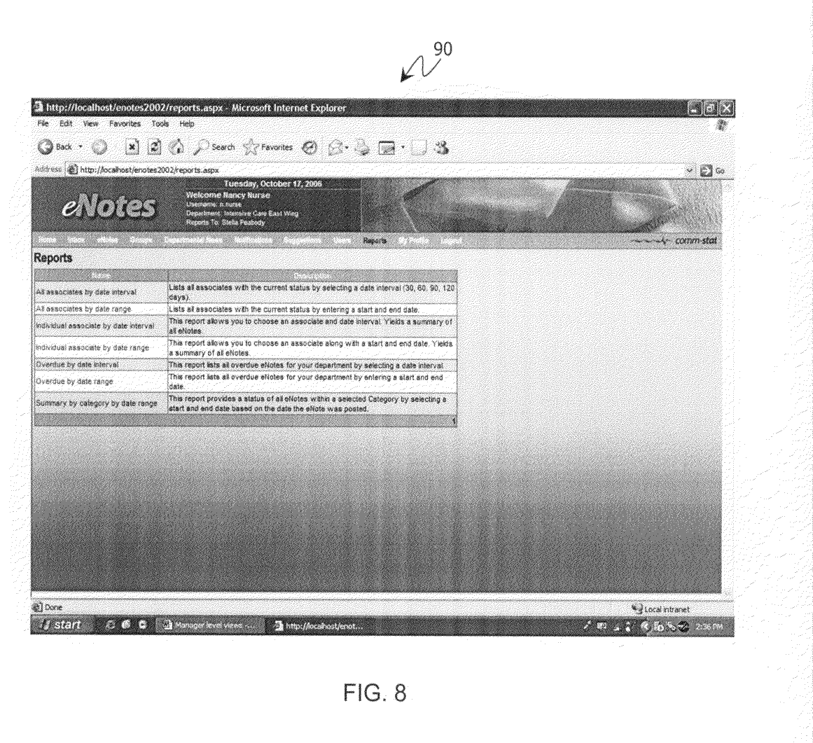

FIG. 8 shows reports screen 90 which includes the welcome banner and the menu bar as discussed above. The screen desirably includes the names of the possible reports, and descriptions thereof. Reports by associate, date range, individual associate by date range, overdue by date interval, overdue by date range and summary by category by date range. Additional and other reporting criteria are possible. This screen generally is used by an author or manager to track compliance with the electronic messages, such as when preparing a month end management report.

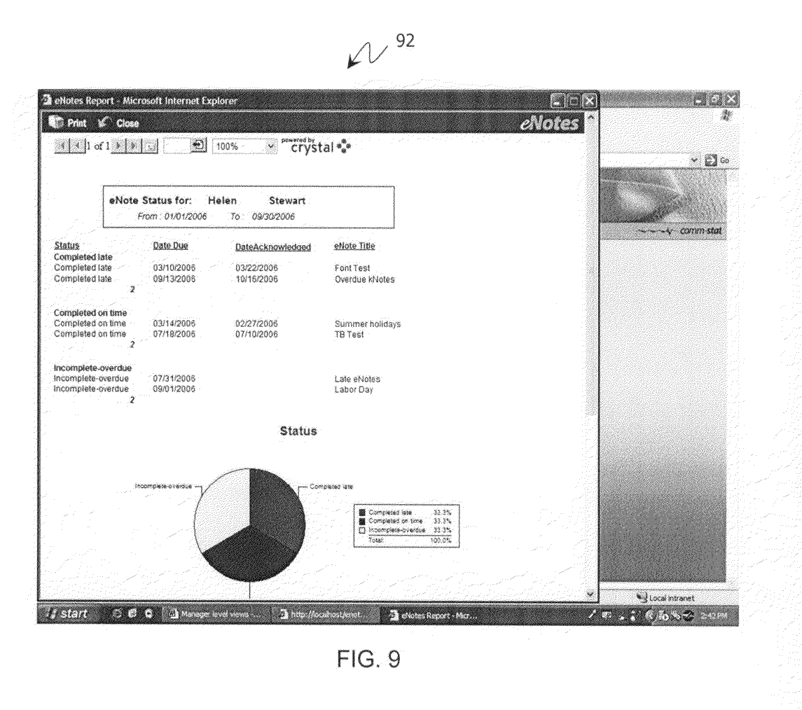

FIG. 9 shows report output 92 which includes print and close buttons. This screen includes navigation buttons to page through the report, such as next page, prior page, specific page number, beginning page and end page. View zoom capabilities are also provided. Those skilled in the art and guided by the teachings herein will appreciate that various combinations and/or arrangements of data from records of the database on the computer system can be retrieved and formatted in various text, tabular and/or graphical forms. According to an embodiment to of this invention, the record is stored in the database and the method further allows querying a report of the status of the electronic messages from the database, where the report includes date interval, employees, overdue, category and combinations thereof.

Thus, the invention provides a convenient accurate and reliable method and system of communicating information across an organization. Specifically, the due dates and accountability responses of the database structure provide the needed tracking assurance while sharing the contents of the electronic messages. The computer system also includes the use of department news which is categorized but not assigned a due date. The computer system includes notifications for sharing important time sensitive bullet items. The computer system also includes suggestions to anonymously provide feedback or a two-way communication channel.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A method for electronically posting and tracking messages to employees, the method comprising:
forwarding an electronic message created by a first employee to a second employee;
displaying the electronic message through a user interface for the second employee;
associating a new message indicator with the electronic message until the electronic message is accessed by the second employee;
displaying to the second employee through the user interface the new message indicator associated with the electronic message;
receiving an electronic accountability response from the second employee indicating the second employee has reviewed and accepts responsibility for a content of the electronic message;
associating a completed message indicator associated with the electronic message upon receiving the electronic accountability response; and
displaying to the second employee through the user interface the completed message indicator associated with the electronic message.

2. The method of claim 1, further comprising:
assigning a due date for receiving the electronic accountability response;
associating an overdue message indicator with the electronic message when the electronic accountability response has not been received by the due date; and
displaying to the second employee through the user interface the overdue message indicator associated with the electronic message.

3. The method of claim 1, further comprising:
associating an incomplete message indicator with the electronic message when the electronic message is accessed by the second employee and closed without receiving the electronic accountability response from the second employee; and
displaying to the second employee through the user interface the incomplete message indicator associated with the electronic message.

4. The method of claim 1, wherein the received electronic accountability response can be accessed by the first employee.

5. The method of claim 1, further comprising automatically storing the received electronic accountability response in a database.

6. The method of claim 1, further comprising requiring a password to allow the second employee to enter the electronic accountability response.

7. The method of claim 1, wherein the method is implemented by a network-based user interface.

8. The method of claim 1, wherein the first employee can obtain an employee review status of the electronic message.

9. The method of claim 1, further comprising:
sending the electronic message to a plurality of employees;
displaying the electronic message through the user interface of each of the plurality of employees.

10. The method of claim 1, further comprising receiving an anonymous electronic response to the electronic message from at least one of the plurality of employees.

11. The method of claim 1, further comprising receiving a category designation for the electronic message, the category designation selected from the group consisting of announcement, birthday, bonus, census, clinical, construction, documentation, emergency, equipment, holidays, human resources, information systems, maintenance, nursing, overtime, pharmacy, phone directory, photos, physicians, planning, policies, presentations, quality improvement, employee recognitions, safety, scheduling, social events, and combinations thereof.

12. The method of claim 1, wherein the second employee is one of a plurality of employees designated in one of a plurality of workgroups as a function of at least one of title, department, job function and task, and further comprising routing the electronic message to each of the employees of the one of the plurality of workgroup.

13. The method of claim 1, wherein the second employee is a medical professional and the electronic message is an untracked general announcement.

14. A method for electronically posting and tracking messages to employees, the method comprising:
displaying through a user interface for a first employee at least one of a list of the employees by name and a list of a plurality of workgroups, wherein each of the employees is designated in at least one of the plurality of workgroups as a function of title, department, job function or tasks;
receiving from the first employee an electronic message and a recipient selection, wherein the recipient selection includes at least one of an employee selection from the list of employees by name and a workgroup selection from the list of the plurality of workgroups;
forwarding the electronic message to a message inbox of each employee associated with the recipient selection;
associating a new message indicator with the electronic message in the message inbox for each employee associated with the recipient selection until the electronic message is accessed;
displaying a request for an accountability response with the electronic message in the message inbox for each employee associated with the recipient selection,
receiving an electronic accountability response from a responding employee of the employees associated with the recipient selection indicating acceptance of responsibility for a content of the electronic message;
displaying a completed message indicator associated with the electronic message in the message inbox of the responding employee upon receiving the electronic accountability response; and
storing a record of the electronic accountability response on a recordable medium that is accessible by the first employee.

15. The method of claim 14, wherein the record is stored in a database and further comprising querying a report from the database of the status of the electronic messages, the report selected from the group consisting of date interval, employees, overdue, category and combinations thereof.

16. The method of claim 14, wherein at least one of accessing the message inbox and entering the accountability response requires entering a password.

17. The method of claim 14, further comprising:
assigning to the electronic message a due date for receiving the electronic accountability response; and
associating and displaying an overdue message indicator with the electronic message in the message inbox when the electronic accountability response has not been received by the due date.

18. The method of claim 14, further comprising:
associating and displaying an incomplete message indicator with the electronic message in the message inbox when the electronic message is accessed from the message inbox and closed without receiving the electronic accountability response.

19. Software code on a recordable medium and executable on a data processing machine for implementing the method of claim 14.

20. A computer system comprising:
software for displaying at least two of the group consisting of date sensitive response tracked electronic messages, non-tracked department news items, non-tracked limited duration notifications; and anonymous suggestion submissions, wherein the electronic messages, department news items, notifications and suggestion submissions reside in a database; and
hardware executing the software and including a recordable media storing the database.
